(19) United States
(12) Patent Application Publication
(10) Pub. No.: US 2008/0095246 A1
(43) Pub. Date: Apr. 24, 2008

(54) METHOD, RECEIVER AND TRANSMITTER FOR ELIMINATING ERRORS IN H.264 COMPRESSED VIDEO TRANSMISSION

(76) Inventors: Zhong LUO, Shenzhen (CN); Bin Song, Shenzhen (CN); Yilin Chang, Shenzhen (CN); Ningzhao Zhou, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/874,680

(22) Filed: Oct. 18, 2007

(30) Foreign Application Priority Data
Apr. 20, 2005 (CN) 200510034336.0

(51) Int. Cl. H04N 7/64

(52) U.S. Cl. 375/240.27; 375/E07.279

(57) ABSTRACT

The invention relates to a method for eliminating errors in compressed video transmission. A method for eliminating errors in H.264 compressed video transmission is disclosed, to eliminating errors in a simple and efficient manner. In the invention, an error information feedback mechanism is used in combination with error concealment and error propagation suppression to eliminate errors. An error is detected and statistics of error information, such as position of lost data, is obtained by sequence numbers of NALUs and information for carrying slices. An error information feedback channel is established in H.264 architecture by defining an extended SEI message. The error propagation is suppressed by segment-wise intra-coding in batches.

### FIELD OF THE INVENTION

The invention relates to a method for eliminating errors in compressed video transmission, and in particular to an error concealment method and an error propagation suppression method in H.264 compressed video transmission.

### BACKGROUND OF THE INVENTION

The video compression standard H.264, developed by International Telecommunication Union Telecommunication Standardization Sector (ITU-T), together with the Moving Picture Experts Group (MPEG) of International Organization for Standardization (ISO) and International Electro-technical Commission (IEC), now gradually becomes a main standard in multimedia communications. Nowadays, a variety of multimedia real-time communication products based on H.264 are emerging, such as video-conferencing, visual telephone, third-generation (3G) mobile communication terminal and network streaming media products. Whether supporting H.264 has become a critical factor for deciding the competitiveness of a product in the market. With the birth of 3G mobile communication system and the rapid development of Internet Protocol (IP) network, video network communication is becoming one of the dominant services in communications. In succession to H.261, H.263, and H.263+, ITU-T released H.264 in the year 2003, which is also the main content of MPEG-4 Part 10. The application of H.264 standard may effectively improve the video encoding efficiency and the network adaptability. With the popularization of H.264, the multimedia communication of IP network and mobile wireless network walk into a new stage of speedy development.

Hereinafter the message structure and transmission mechanism will be described. H.264 employs a layered structure, in which a video coding layer (VCL) and a network abstraction layer (NAL) are defined. The NAL is specially designed for network transmission, allows for compressed video transmission over different networks, thus providing more “affinity” of networks. H.264 introduces an IP packet-oriented coding mechanism, which facilitates the packet transmission in networks, supports the stream media transmission of compressed video in networks, and thus provides better error resilience. This may canter for the requirements in wireless transmission of compressed video which otherwise would have a high packet loss rate and a severe interference. In H.264, all data to be transmitted, including picture data and other information, are encapsulated into uniformly formatted packets, i.e., network abstraction layer units (NALUs). Each NALU is a length-variable character string with certain syntactical elements, including one byte of header information representing data types, and several bytes of payload data (the number of the payload data bytes is an integer). One NALU carries a slice, respective type data segments or a sequence parameter set or picture parameter set. To enhance the reliability of data transmission, each picture is divided into several slices. Each slice is carried by a NALU, and is partitioned into several macro-blocks of smaller sizes, i.e., the smallest units for processing. In general, the slices in the same spatial position in two temporally adjacent pictures are correlated with each other, while the slices in different spatial positions are independent from each other, so as to prevent errors from propagating between slices.

H.264 data includes the texture data, sequence parameters, picture parameters and supplemental enhancement information (SEI) of non-reference pictures, as well as texture data of reference pictures and the like. The SEI message is a general term, meaning the messages having supplemental functions in the decoding, displaying and the like of H.264-based compressed video. The prior art defines a variety of SEI messages, while reserving some SEI reservation messages for possible future extensions. In accordance with H.264, SEI message is not necessary for reconstructing luminance image and chroma image during decoding. It is not necessary for a decoder in compliance with H.264 to do any processing for SEI. In other words, not all terminals in compliance with the basic requirements of H.264 are able to process SEI messages. Sending SEI has no effect on a terminal without SEI processing capability, the terminal simply ignores the SEI messages which it can not process. In accordance with SEI syntax rules, a user may transport a self-defined message by using the reservation messages, so as to enable function extension.

Because of the highly efficient coding algorithms employed in H.264, the compressed video code stream has an enhanced sensitivity to channel errors, such that even a single primary error is possible to cause a sharp degradation in the quality of the recovered video. For example, in an IP network, though a number of Quality of Service (QoS) management policies of bearer layer are utilized, the network bandwidth fluctuation is inevitable, resulting in frequent packet loss and packet delay, or other issues. A transmission error due to such issues is called Erasure Error, which is different from the Random bit error in the conventional circuit switched networks. It is more difficult to prevent and correct an erasure error than a random bit error. In the practical H.264-based compressed video communication, the picture quality degradation due to erasure errors caused by packet loss or the like is very severe, which is even likely to incur a system disruption on the decoding side. This is because H.264 has, compared with other compressed video coding standards, a stronger capability, a higher efficiency and richer functions, but has a poor error resilience nature for erasure errors. Therefore, in H.264-based compressed video communication, it is necessary to employ an effective resilience technique for erasure errors (such as packet loss), in combination with a number of video error resilience methods, so as to ensure the quality of recovered pictures.

In a typical IP packet network, erasure error is the packet loss error. There exist a variety of packet loss resilience techniques, such as Erasure Codes, Automatic Retransmission Request (ARQ), Interleaving, and Error Concealment. These techniques may be classified into two categories according to the different intentions thereof: (a) Active error prevention, i.e., an error prevention method is employed in advance. For example, a redundancy mechanism may be introduced, so as to ensure the fewest possible packet loss or to guarantee that the receiver may recover a small amount of lost data. (b) Error compensation, i.e., an error compensation method is employed in the case of errors. For example, in the case of a severely deteriorated network environment, the packet loss rate is so high that the active error prevention method does not function well. In this case, it is necessary to compensate the errors which have already occurred.

The error eliminating method of error compensation may be classified into error concealment and error propagation suppression according to the different concerns thereof. Error concealment mainly concerns about the compensation for the current influence of errors. For example, when a current video picture or slice is lost at a receiver, the picture can not be displayed properly. In this case, a compensation method has to be employed, so as to minimize the adverse influence for users. Error propagation suppression mainly concerns about how to eliminate the subsequent influence due to the spatial and temporal propagation of the errors. For example, when a picture or part of a picture is lost at the receiver, the error may be propagated into subsequent pictures in time domain because the picture may be a prediction reference picture for the subsequent pictures. Or this error of the picture may be propagated into other positions of the picture through spatial prediction because of the intra-picture prediction as well as the loop filtering in H.264. The error propagation suppression is to employ a method to restrict the influence of an error within a spatial area and within a temporal range, in order to avoid a communication failure, or even turbulence and disrupt in a decoding system.

As can be seen, in an error prone environment, propagation of the error not only may incur quality degradation in the recovered picture of the error picture, but also may cause the subsequent pictures un-recoverable. In this case, even if an error concealment technique is utilized by the decoding party, the quality degradation in the recovered picture is inevitable. In addition, The ARQ method for retransmitting the error data is generally not employed because of the strict real-time requirements of the video communication.

Through the error concealment method, such as a simple substitution or a complex prediction or interpolation by using the correct data of the part(s) adjacent to the error part in space and time, the error may be compensated. This may be implemented at the receiver without the participation of the transmitter. However, error propagation is much more complicated. The elimination and suppression of the error propagation require the cooperation of the receiver and transmitter to assume a proper policy.

It shall be noted that the error concealment may also incur error propagation. In fact, the error concealment may cause mismatch between the buffer contents of reconstructed pictures in the encoding and decoding parties, resulting in a temporal error propagation. For example, when a packet loss occurs in (n−1)th picture, the decoding party may utilize the picture data in the corresponding positions of (n−2)th picture to conceal the error. However, the transmitter is not aware of the packet loss in (n−1)th picture and uses the correct (n−1)th picture to encode nth picture, while the decoding party uses (n−2)th picture instead of (n−1)th picture to decode the nth picture. In this way, the error is propagated.

The existing error eliminating methods are all separate error concealment methods or error propagation suppression methods, including a variety of methods with different implementation details. The error concealment methods include temporal concealment, spatial concealment, joint spatio-temporal concealment, etc. The error propagation suppression methods include intra-coding, identification, adaptive intra-picture block update, etc.

In a temporal concealment method, lost data is deduced from the information of a picture adjacent to the lost data in time. The method for deducing is as follows: the lost data is substituted by the data at the same position in an adjacent picture; and in consideration of the factor of motion prediction, a motion prediction is performed based on the data of the adjacent picture. In addition to this method, there may be other more complicated conceal methods, but the calculation amount is considerably great.

In a spatial concealment method, the data of an area which is adjacent to the area of the lost data in space is used to conceal an error. Similarly, there are the following methods: simple substitution using an adjacent area; lost data deduction according to a plurality of spatially adjacent areas based on data integration, such as spatial interpolation; and algebraic inversion method. In an algebraic inversion method, a packet loss process is modeled with a linear model, the input of the model is the data before the packet loss, and the output of the model is the data received properly. The input is deduced inversely using the output with an algebraic inversion method, for example, the least square method. The result of the inversion is used to substitute the error data. However, the calculation amount of this method is considerably great.

A joint spatio-temporal concealment method is an error concealment method with joint utilization of the space and time domains. For example, a policy is employed to determine which one of a spatial concealment method and a temporal concealment method is better according to the properties of the lost data as well as the conditions of temporally adjacent data and spatially adjacent data. Then the better policy is implemented. Alternatively, the spatial data and temporal data are integrated to perform a joint concealment.

In an error propagation suppression method based on intra-coding, intra-coding is applied to a macro-block influenced by an error, in other words, a precise error tracking is conducted using forward dependency of motion vectors. Applying intra-coding to the macro-block influenced by the error can effectively prevent the error from propagating. Firstly, inter-picture dependency caused by motion compensation is provided. Then the “energy” of the error is calculated based on the forward dependency of motion vectors and correlation of weight factors, intra-coding is applied to the macro-block having the greatest “energy”. In this way, the error propagation may be prevented.

In an error propagation suppression method based on identification, a macro-block influenced by an error is identified. The identified macro-block will not be used as a reference picture during coding. Thus the propagation of the error may be prevented directly. In this method, a feedback mechanism from the receiver to the transmitter is required. The receiver feeds the information of the lost data back to the transmitter. The transmitter identifies all the pixels following the error macro-block in the same block group with certain value. So, the identified area will not be referenced when encoding the several following pictures. In this way, the error is prevented from propagating in the receiver.

In an error propagation suppression method based on adaptive intra-picture block update policy, the vulnerability of each coded macro-block to channel errors is measured based on “Error sensitivity measure (ESM)” of the encoding party, then an adaptive intra-picture block update is performed. This method does not require the feedback information. Firstly the encoding party initializes the value of “Error sensitivity measure”. The more distant from a synchronous flag a macro-block is, the more sensitive to an error the macro-block is. The greater the number of bits in a coded macro-block is, the more susceptible to be corrupted by an error the coded macro-block is. During encoding, this measure is updated by accumulating error sensitivity measure value of each macro-block. Then, a selection is made to the macro-blocks according to the overall error sensitivity measure.

In practice, the above technical schemes have the following problems: the above error concealment methods can only temporarily conceal the distortion due to errors. Further, the simpler methods do not function well, while the more complicated methods may incur a considerately large calculation amount. Moreover, concealment and substitution may aggravate the error propagation.

The mechanisms for implementing the above error propagation suppression methods are all relatively complicated. This may increase the load of networks, and the algorithms are too complicated to achieve real-time processing. In addition, these propagation suppression methods can not completely eliminate the adverse influence of the error propagation, thus resulting in quality degradation of the recovered pictures.

The main reasons lie in that the substitution mechanism used by the separate error concealment methods may incur error propagation, and the error propagation suppression methods require complicated mechanisms or an extra feedback channel, which wastes the system resources and network bandwidth resources.

### SUMMARY OF THE INVENTION

The invention provides a method for eliminating errors in H.264 compressed video transmission, to prevent error propagation resulting from error concealment, so as to improve the quality of the compressed video transmission.

A method for eliminating errors in H.264 compressed video transmission according to the invention is provided. The method includes:
performing, by a receiver, statistics of error information, and concealing the error; feeding, by the receiver, the error information back to a transmitter; suppressing, by the transmitter, error propagation based on the error information.

Optionally, the receiver may carry the error information in an extended compensation enhancement message and feed the error information back to the transmitter.

In addition, the payload type of the extended compensation enhancement message is defined as carrying the error information.

In addition, suppressing the error propagation may include: obtaining, by the transmitter, position information of a lost slice based on the error information, intra-coding the lost slice segment-wise in several batches to eliminating the error propagation; the lost slice corresponding to the error.

In addition, intra-coding segment-wise in several batches may includes:
C1. partitioning the lost slice to obtain a segment of contiguous macro-blocks to form a new slice, wherein remaining macro-blocks still belongs to the lost slice;
C2. intra-coding the new slice and transmitting the intra-coded new slice in a next picture, wherein the new slice is encoded according to normal H.264 rules after this moment;
C3. in the next picture, determining whether the lost slice contains a remaining macro-block, if the lost slice contains a remaining macro-block, returning to step C1.

In addition, size of the segment of contiguous macro-blocks meets the following condition that:
when the segment of contiguous macro-blocks is intra-coded, data rate of local picture is within an H.264 data rate control range.

In addition, partitioning the lost slice may further include:
partitioning the lost slice from a first macro-block contained in the lost slice to obtain a segment of contiguous macro-blocks to form a new slice; wherein if a number of macro-blocks currently contained in the lost slice is greater or equals to a predefined parameter P, the number of macro-blocks contained in the segment of contiguous macro-blocks is P, otherwise, the segment of contiguous macro-blocks contains all macro-blocks contained in the lost slice;
after the segment of contiguous macro-blocks is partitioned, if there are macro-blocks remaining in the lost slice, proceeding to step C2, wherein the remaining macro-blocks still belong to the lost slice;

The predefined parameter P meets the following condition that
when P macro-blocks are intra-coded, data rate of local picture keeps within an H.264 data rate control range.

In addition, performing statistics of error information, and concealing the error may include:
detecting the error by the receiver, and performing statistics of the error information; when detecting occurrence of the error, re-synchronizing, by the receiver, with compressed video information; concealing the error by the receiver based on the error information.

In addition, detecting the error and performing statistics of the error information is performed by the receiver based on continuity of sequence numbers of network abstraction layer units.

In addition, detecting the error by the receiver and performing statistics of the error information may include: obtaining position information of a lost slice based on discontinuity of the sequence numbers of the network abstraction layer units, the position information comprising a sequence number of a picture whereby the lost slice is numbered, and position of the lost slice in the picture.

In addition, concealing the error may include:
substituting, by the receiver, the lost slice with a slice at a corresponding position in a previous picture followed by the picture at which the lost slice is located.
According to an embodiment of the invention, there is provided a method for eliminating an error in H.264 compressed video transmission. The method includes: performing, by a receiver, statistics of error information, and concealing an error; and feeding, by the receiver, the error information back to a transmitter.
According to an embodiment of the invention, there is provided a method for eliminating an error in H.264 compressed video transmission. The method includes: receiving, by a transmitter, error information obtained and sent by a receiver; and suppressing, by the transmitter, error propagation based on the error information.
According to an embodiment of the invention, there is provided a receiver for eliminating an error in H.264 compressed video transmission. The receiver includes: means for performing statistics of error information, and concealing an error; and means for feeding the error information back to a transmitter.
According to an embodiment of the invention, there is provided a transmitter for eliminating an error in H.264 compressed video transmission. The transmitter includes: means for receiving error information obtained and sent by a receiver; and means for suppressing error propagation based on the error information.

As can be seen from comparison, the technical schemes according to the embodiments of the invention are different from those of the prior art in that an error information feedback mechanism is used in combination with error concealment and error propagation suppression to eliminate errors.

In addition, an error is detected and the error information, such as position of the lost data, is obtained statistically by using the sequence numbers of NALUs and the information for carrying slices.

An error information feedback channel is established inside the H.264 architecture by defining an extended SEI message.

The fragment-wise intra-coding in batches is employed to suppress error propagation.

These differences in technical schemes bring about apparent bonus effects. The error concealment and error propagation suppression are combined, to prevent error propagation resulting from error concealment. This brings about a desired effect of error elimination and an improved quality in compressed video transmission with a low complexity.

Further, the statistics by using sequence numbers of NALUs not only ensures the veracity of the statistic information, but also saves the system resources.

Using the extended SEI messages may save the overhead, simplify the mechanism, and guarantee the system compatibility.

The fragmented successive intra-coding method is simple in implementation and effective in prevention of error propagation, may reduce the complexity of error elimination and guarantee the stability of the compressed video transmission.

### BRIEF DESCRIPTION OF THE DRAWINGS

FIG. 1 is a flow chart illustrating a method for eliminating errors in H.264 compressed video transmission according to a first embodiment of the invention;

FIG. 2 is a schematic diagram illustrating the principle of suppressing error propagation based on fragmented successive intra-coding according to a second embodiment of the invention.

### DETAILED DESCRIPTION OF THE EMBODIMENTS

The invention will be further described in conjunction with the figures, for better understanding of the object, the technical schemes and advantages of the invention.

The invention starts from two aspects, i.e., error concealment and error propagation suppression, combines an error concealment policy at a receiver and an error propagation suppression policy at a transmitter, so as to reduce the degradation of video quality caused by an error as much as possible, and avoid the propagation of the error. For the error concealment, a simple substitution scheme is employed so as to compensate the loss caused by the error with a relatively lower complexity. For the error propagation suppression, an error information feedback channel is established through existing H.264 channels, intra-coding is performed according to the feedback information, so as to suppress the error propagation without any extra load for network, to ensure the robustness of compressed video code stream to errors, and to prevent the error propagation resulted from error concealment.

In the invention, the receiver discovers information of lost data, such as position of an error slice which contains the lost data, through statistics of the sequence numbers of Network Abstraction Layer Units (NALUs). The receiver performs a simple substitution of the lost data by using an efficient algorithm so as to conceal the error of lost data. The receiver feeds error information, i.e., information of the lost data, back to the transmitter. An error information feedback channel from the receiver to the transmitter is established by using extended H.264 SEI messages. When receiving the error information, the transmitter updates the error slice segment-wise in several batches by using the segment-wise intra-coding in batches, to prevent propagation of the error.

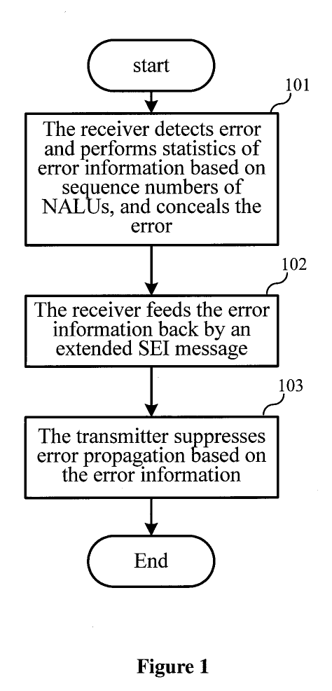

FIG. 1 is a flow chart illustrating a method for eliminating errors in H.264 compressed video transmission according to a first embodiment of the invention. In the H.264 compressed video transmission, the transmitter encodes video stream data to be transmitted to obtain compressed video stream data, encapsulates the compressed video stream data into NALUs, and transmits the NALUs via packets to the receiver. The receiver receives and decodes the packets. The receiver has to determine whether there is a loss in the compressed video stream data, so as to execute subsequent error elimination operations. The error elimination operations include concealment, feedback and propagation elimination.

In block 101, the receiver determines whether there is lost data according to whether the sequence numbers of the NALUs are continuous, and takes statistics of information of the lost data, i.e., error information. As described above, a NALU is a basic unit in H.264 compressed video stream data transmission. Each NALU has a unique continuous sequence number. Therefore, the receiver may know which NALUs are lost according to the continuity of the sequence numbers of the NALUs, and apply an error concealment policy to conceal the lost data. The statistics using the sequence numbers of the NALUs not only ensures the veracity of statistic information, but also requires no extra bearing overhead because the existing data information is utilized.

First, the receiver identifies the header information of the received NALUs to obtain the sequence numbers, and detects an error if the sequence numbers are not continuous. The receiver may know the lost data that should be carried by a lost NALU through a previous NALU, so as to locate the lost data caused by the error. For example, if the previous NALU of the lost NALU carries the 1^{st} slice of Nth picture, the receiver may deduce that the slice carried by the lost NALU should be the next slice of the Nth picture based on transmission order.

Next, the receiver needs to resynchronize with the compressed video stream data, this is because only when the receiver synchronizes with the compressed video steam data that it is possible to correctly receive the compressed video steam data during H.264 compressed video stream data transmission. Once the stream data has a discontinuity, the receiver needs a resynchronization, i.e., the decoder is resynchronized by finding header information of a next NALU following the discontinuity. During this procedure, the receiver also needs to determine the quantity and positions of lost NALUs via the sequence number of the next NALU.

Next, the receiver conceals the error. The NALU of the lost data is dropped, thus the whole slice carried by this NALU is lost. One error concealment policy is a simple substitution, i.e., substituting the lost data with spatially or temporally adjacent data. For example, the recovered picture data of a slice at the corresponding position of a previous picture followed by the picture of the lost data may be used to conceal the error.

In the first embodiment of the invention, the receiver employs a simple error concealment method with a high computational efficiency. This method compromises the concealment effect and the penalty, instead of pursuing the best concealment effect. In other words, a desirable error concealment effect is achieved with a low complexity. A person of ordinary skill in the art shall appreciate that the receiver may employ a more complicated error concealment method having a better concealment effect when knowing the error information, so as to reduce the loss of video effect for users as much as possible, which also falls within the spirit and scope of the invention.

In block 102, when obtaining the error information, the receiver feeds the error information back to the transmitter. A feedback channel is required to feed back the error information. In the first embodiment of the invention, existing H.264 communication mechanism is utilized to reduce the load of network and simplify the implementation mechanism. In other words, an extended SEI message is defined to carry the error information, to establish the feedback channel, so that the transmitter may prevent error propagation based on the error information. In f act, combining the error information feedback mechanism with the error propagation suppression policy of the transmitting may prevent the error propagation resulted from the error concealment policy implemented by the receiver.

An extended H.264 SEI message is used to provide an information feedback mechanism from the receiver to the transmitter, so that the transmitter may know which NALUs are lost in time. In this way, the transmitter may effectively suppress error propagation in time, i.e., prevent the error resulted from the lost data from propagating. In fact, in the error propagation suppression method, if the transmitter predicts by itself so as to prevent error propagation, without the feedback information returned from the receiver in time, the suppression effect will discount, and the computation will be very complicated.

The benefits of establishing an information feedback mechanism inside H.264 architecture lie in that the overhead of network bandwidth and the system resources may be saved without any influence on intercommunication. Hereinafter, the method for defining an extended SEI message will be described. As described above, an SEI message is also carried by the basic unit NALU of H.264 code stream. Each SEI field contains one or more SEI messages. An SEI message includes SEI header information and SEI payload. The SEI header information includes two code words, i.e., payload type and payload size. The length of payload type is not constant, for example, one byte when the payload type is within the scope of 2 to 255, and two bytes (0xFF00 to 0xFFFE) when the payload type is within the scope of 256 to 511, and so on. In this way, a user may define any number of payload types. In the existing H.264 standard, the payload types 0 to 18 have been defined as having certain meanings, such as buffer period, picture timing. As can be seen, the SEI field defined in H.264 may store sufficient user-defined information as required. In the first embodiment of the invention, an extended SEI message for carrying statistic information is defined in the reserved SEI payload type.

An SEI message is an additional message, the absence or presence of which has no influence on the normal video communication. Thus, the extended SEI message according to the invention has no influence on the existing video communication, and may be used generally. In other words, if the terminals of the two communication parties both support the technical scheme according to the invention, an SEI message may be used to transfer statistic data of a lost packet, so as to achieve adaptive protection with different levels of capability. If one communication party does not support the technical scheme according to the invention, the normal video communication will not be influenced. As can be see, the self-defined extended SEI message has no influence on the compatibility of H.264-based compressed video communication system. In addition, another advantage of using SEI message to transfer statistic data of a lost packet is that the overhead may be saved. SEI is a part of H.264 code stream, thus using SEI message, i.e., the H.264 code stream itself, to carry the statistic data of the lost packet does not require to establish and maintain any extra channel. Thus, the transmission is efficient and the implementation is relatively simple.

A person of ordinary skill in the art shall appreciate that the error information feedback channel from a receiver to a transmitter may be established by defining a communication protocol and creating a private channel, or by using other reserved channels based on H.264. In this way, the error concealment and error propagation suppression may also be joined together without departing from the spirit and scope of the invention.

In block 103, the transmitter begins to suppress error propagation based on the feedback error information. The error propagation suppression method utilizing the error information has a better effect than the existing error propagation suppression methods without feedback. With the error information, such as the position of a lost slice, the transmitter may take a prevention measure directed to the lost slice. For example, the lost slice will not be used as a reference frame during the subsequent coding process, so that the dependency for this lost slice during the decoding process of the receiver may be shortened as much as possible.

H.264 coding is based on slice, the data of slices at the same position in two temporally adjacent pictures are reference-correlated with each other. The data of a slice at a position in a picture is predictively encoded based on a slice at the same position in a previous picture followed by the picture. Thus, the error propagation is limited within slices at the same position. In a second embodiment of the invention, a segment-wise intra-coding in batches is employed. Particularly, when an error occurs in transmission, the slices at the same position in the following pictures are segmented into new slices. For example, a number of macro-blocks, for example P macro-blocks obtained from the segmenting, form a new slice, and the new slice is intra-coded. In this way, the reference or dependency of the new slice on the lost slice may be eliminated. H.264 compressed video real-time transmission system employs a data rate control scheme to restrict fluctuation of the data of each picture, to balance amount of the data of each picture, to improve the stability of compressed video transmission, so as to ensure the transmission quality. Therefore, the amount of data to be intra-coded at one time, i.e., the number of macro-blocks, in each picture should not be very large, so as not to exceed the data rate control range of H.264.

A person of ordinary skill in the art shall appreciate that, the transmitter may employ other methods, for example, marking a lost slice, to avoid reference to the lost slice in the subsequent coding after the transmitter receives the feedback error information, which may also combine the error concealment and error propagation suppression, without departing from the spirit and scope of the invention.

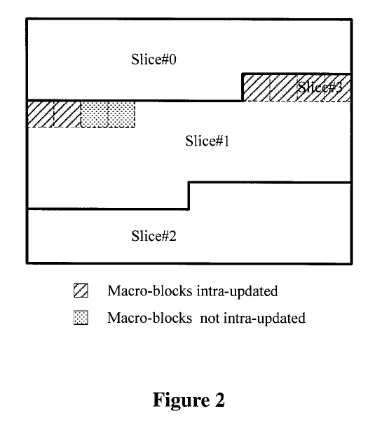

FIG. 2 is a schematic diagram illustrating the principle of suppressing error propagation of the segment-wise intra-coding in batches according to the second embodiment of the invention. When an unrecoverable error of packet loss occurs, the receiver detects and feeds error information back to the transmitter. Particularly, the receiver sends information about a picture, at which the slice of lost data is located, and position of the slice in the picture to the transmitter by an extended SEI message. The transmitter extracts position information of the slice of lost data from the extended SEI message. For example, as shown in FIG. 2, each picture is partitioned into 3 slices, i.e., Slice#0, Slice#1, and Slice#3, and Slice#1 of nth picture is lost. Then, the transmitter performs the segment-wise intra-coding in batches.

Firstly, in the nth picture, an encoder partitions Slice#1 into a plurality of macro-blocks in a macro-block scan order. Among the plurality of macro-blocks, P macro-blocks, starting from the beginning position, form a new Slice#3, while the remaining macro-blocks still belong to Slice#1. At this time, there are 4 slices. The new Slice#3 is intra-coded.

Next, in (n+1)th picture, new Slice#3 obtained from the partitioning is intra-coded and transmitted as Slice#3, while the other slices are encoded normally.

Next, it is necessary to determine whether there is any remaining macro-block in Slice#1. If there is, the process returns to the first step, i.e., in a next picture, the remaining macro-blocks in Slice#1 are segmented to form a new slice, and the new slice is intra-coded and transmitted. This process is repeated until all the macro-blocks are processed. If the number of macro-blocks in a Slice#1 is not an integer multiple of P, the number of macro-blocks remaining last time is smaller than P.

The number P of macro-blocks obtained from partitioning each time should be large enough so as to reduce the number of times of partitioning, lower processing delay, and minimize the range influenced. However the number P should also meet the requirement of the above-mentioned H.264 data rate control range. The numbers of macro-blocks obtained from partitioning may be different each time. However, the number of macro-blocks obtained from the last partitioning should make all the macro-blocks in the lost slice be processed.

For example, a picture of compressed video stream data includes 396 macro-blocks. Initially the picture is so partitioned that 64 macro-blocks form one slice. In other words, macro-blocks 0-63 form Slice#0, macro-blocks 64-127 form Slice#1, macro-blocks 128-191 form Slice#2, and so on. From the computation based on data rate, it is determined that number P appropriate for a segment is 8. When Slice#1 in nth picture is lost, the 64 macro-blocks in Slice#1 should be intra-coded segment-wise in several batches. Firstly, the first 8 macro-blocks in (n+1)th picture are selected and intra-coded to form a Slice#k. Slice#k in (n+2)th picture may be predictively encoded normally, while the next 8 macro-blocks are intra-coded to form a Slice#k+1. This process is repeated until the last 8 macro-blocks in (n+8)th picture are intra-coded to form a Slice#k+7. Thus, the error propagation suppression process with the segment-wise intra-coding in batches is completed. The above mentioned k is an integer.

Finally, the experimental results before and after the application of the method of the invention will be compared by using the experiment data.

The following two tables compare the qualities of recovered pictures before and after the application of the error concealment and error propagation suppression method by using the experimental data. Two internationally popular bench-mark testing video sequences for measuring quality of image processing and compressing coding, i.e., the Foreman sequence and the Container sequence, are utilized herein. The comparison is done by using peak signal-to-noise ratio (PSNR) which is the most important criterion for quality measure. The higher the PSNR is, the better the quality is. In the following two tables, PSNR1 indicates the PSNR without the error concealment and error propagation suppression method, and PSNR2 indicates the PSNR with the error concealment and error propagation suppression method.

Foreman picture sequence

| | Packet loss rate | | | | | | | | |
|---|---|---|---|---|---|---|---|---|---|
| | 0% | 2% | 4% | 6% | 8% | 10% | 12% | 14% | 16% |
| PSNR1 | 36.56 | 26.69 | 23.80 | 21.81 | 19.32 | 20.01 | 18.59 | 18.74 | 17.45 |
| PSNR2 | 36.56 | 35.22 | 34.08 | 33.25 | 31.94 | 31.27 | 30.32 | 29.63 | 29.34 |

Container picture sequence

| | Packet loss rate | | | | | | | | |
|---|---|---|---|---|---|---|---|---|---|
| | 0% | 2% | 4% | 6% | 8% | 10% | 12% | 14% | 16% |
| PSNR1 | 35.97 | 34.61 | 32.17 | 30.84 | 29.91 | 28.87 | 27.71 | 26.58 | 25.51 |
| PSNR2 | 35.97 | 35.37 | 34.82 | 34.65 | 34.10 | 33.19 | 32.33 | 31.85 | 31.38 |

Though the invention has been illustrated and described with reference to some preferred embodiments of the invention, a person of ordinary skill in the art shall appreciate that various variations in detail and form may be made without departing from the spirit and scope of the invention.

What is claimed is:

1. A method for eliminating an error in H.264 compressed video transmission, comprising:
performing, by a receiver, statistics of error information, and concealing an error;
feeding, by the receiver, the error information back to a transmitter;
suppressing, by the transmitter, error propagation based on the error information.

2. The method for eliminating an error in H.264 compressed video transmission according to claim 1, wherein, the method further comprises: carrying, by the receiver, the error information in an extended compensation enhancement message; extracting, by the transmitter, the error information from the extended compensation enhancement message.

3. The method for eliminating an error in H.264 compressed video transmission according to claim 2, wherein, a payload type of the extended compensation enhancement message is defined as for carrying the error information.

4. The method for eliminating an error in H.264 compressed video transmission according to claim 1, wherein, suppressing the error propagation comprises:
obtaining, by the transmitter, position information of a lost slice based on the error information, intra-coding the lost slice segment-wise in several batches to eliminate the error propagation; the lost slice corresponding to the error.

5. The method for eliminating an error in H.264 compressed video transmission according to claim 4, wherein, intra-coding the lost data segment-wise in several batches comprises:
C1. partitioning the lost slice to obtain a segment of contiguous macro-blocks to form a new slice, wherein remaining macro-blocks still belongs to the lost slice;
C2. intra-coding the new slice and transmitting the intra-coded new slice in a next picture, wherein the new slice is encoded according to normal H.264 rules after this moment;
C3. in the next picture, determining whether the lost slice contains a remaining macro-block, if the lost slice contains a remaining macro-block, returning to step C1.

6. The method for eliminating an error in H.264 compressed video transmission according to claim 5, wherein, size of the segment of contiguous macro-blocks meets the following condition that:
when the segment of contiguous macro-blocks is intra-coded, data rate of local picture is within an H.264 data rate control range.

7. The method for eliminating an error in H.264 compressed video transmission according to claim 6, wherein, partitioning the lost slice comprises:
partitioning the lost slice from a first macro-block contained in the lost slice to obtain the segment of contiguous macro-blocks to form the new slice; wherein if number of macro-blocks currently contained in the lost slice is greater than or equals to a predefined parameter P, the number of macro-blocks contained in the segment of contiguous macro-blocks is P, otherwise, the segment of contiguous macro-blocks contains all macro-blocks contained in the lost slice;
after the segment of contiguous macro-blocks is partitioned, if there are macro-blocks remaining in the lost slice, proceeding to step C2, wherein the remaining macro-blocks still belong to the lost slice;
wherein the predefined parameter P meets the following condition that:
when P macro-blocks are intra-coded, data rate of local picture keeps within an H.264 data rate control range.

8. The method for eliminating an error in H.264 compressed video transmission according to claim 1, wherein, performing by the receiver statistics of the error information, and concealing the error comprise:
detecting the error by the receiver, and performing statistics of the error information;
when detecting occurrence of the error, re-synchronizing, by the receiver, with compressed video information;
concealing the error by the receiver based on the error information.

9. The method for eliminating an error in H.264 compressed video transmission according to claim 8, wherein, detecting the error and performing statistics of the error information are performed by the receiver based on continuity of sequence numbers of network abstraction layer units.

10. The method for eliminating an error in H.264 compressed video transmission according to claim 9, wherein, detecting the error by the receiver and performing statistics of the error information comprises: obtaining position information of the lost slice based on discontinuity of the sequence numbers of the network abstraction layer units, the position information comprising a sequence number of a picture, whereby the lost slice is numbered, and position of the lost slice in the picture.

11. The method for eliminating an error in H.264 compressed video transmission according to claim 10, wherein, concealing the error comprises:
substituting, by the receiver, the lost slice with a slice at a corresponding position in a previous picture followed by the picture at which the lost slice is located.

12. A method for eliminating an error in H.264 compressed video transmission, comprising:
performing, by a receiver, statistics of error information, and concealing an error; and
feeding, by the receiver, the error information back to a transmitter.

13. The method for eliminating an error in H.264 compressed video transmission according to claim 12, wherein the method further comprises:
carrying, by the receiver, the error information in an extended compensation enhancement message,
feeding the error information back to the transmitter comprises:
sending the extended compensation enhancement message to the transmitter.

14. The method for eliminating an error in H.264 compressed video transmission according to claim 12, wherein, performing by the receiver statistics of the error information and concealing the error comprises:
detecting the error by the receiver, and performing statistics of the error information;
when detecting occurrence of the error, re-synchronizing, by the receiver, with compressed video information;
concealing the error by the receiver based on the error information.

15. The method for eliminating an error in H.264 compressed video transmission according to claim 14, wherein, detecting the error by the receiver and performing statistics of the error information comprises: obtaining position information of the lost slice based on discontinuity of the sequence numbers of the network abstraction layer units, the position information comprising a sequence number of a picture, whereby the lost slice is numbered, and position of the lost slice in the picture.

16. A method for eliminating an error in H.264 compressed video transmission, comprising:
receiving, by a transmitter, error information obtained and sent by a receiver; and
suppressing, by the transmitter, error propagation based on the error information.

17. The method for eliminating an error in H.264 compressed video transmission according to claim 16, wherein, suppressing the error propagation comprises:
obtaining, by the transmitter, position information of a lost slice based on the error information, intra-coding the lost slice segment-wise in several batches to eliminate the error propagation; the lost slice corresponding to the error.

18. The method for eliminating an error in H.264 compressed video transmission according to claim 17, wherein, intra-coding the lost slice segment-wise in several batches comprises:
C1. partitioning the lost slice to obtain a segment of contiguous macro-blocks to form a new slice, wherein remaining macro-blocks still belongs to the lost slice;
C2. intra-coding the new slice and transmitting the intra-coded new slice in a next picture, wherein the new slice is encoded according to normal H.264 rules after this;
C3. in the next picture, determining whether the lost slice contains a remaining macro-block, if the lost slice contains a remaining macro-block, returning to step C1.

19. A receiver for eliminating an error in H.264 compressed video transmission, comprising:
means for performing statistics of error information, and concealing an error; and
means for feeding the error information back to a transmitter.

20. The receiver according to claim 19, wherein the receiver further comprises:
means for carrying the error information via an extended compensation enhancement message,
the means for feeding the error information back to a transmitter comprises: means for sending the extended compensation enhancement message.

21. The receiver according to claim 19, wherein, the means for performing statistics of the error information and concealing the error comprises:
means for detecting the error and performing statistics of the error information;
means for re-synchronizing with compressed video information when detecting occurrence of the error; and
means for concealing the error based on the error information.

22. The receiver according to claim 21, wherein, the means for detecting the error and performing statistics of the error information comprises: means for obtaining position information of the lost slice based on discontinuity of the sequence numbers of the network abstraction layer units, the position information comprising a sequence number of a picture, whereby the lost slice is numbered, and position of the lost slice in the picture.

23. A transmitter for eliminating an error in H.264 compressed video transmission, comprising:
means for receiving error information obtained and sent by a receiver; and
means for suppressing error propagation based on the error information.

24. The transmitter according to claim 23, wherein, the means for suppressing the error propagation comprises:
means for obtaining position information of a lost slice based on the error information, and intra-coding the lost slice segment-wise in several batches to eliminate the error propagation; the lost slice corresponding to the error.

25. The transmitter according to claim 24, wherein, the intra-coding the lost slice segment-wise in several batches comprises:
C1. partitioning the lost slice to obtain a segment of contiguous macro-blocks to form a new slice, wherein remaining macro-blocks still belongs to the lost slice;
C2. intra-coding the new slice and transmitting the intra-coded new slice in a next picture, wherein the new slice is encoded according to normal H.264 rules after this;
C3. in the next picture, determining whether the lost slice contains a remaining macro-block, if the lost slice contains a remaining macro-block, returning to step C1.
